(19) United States
(12) Patent Application Publication
(10) Pub. No.: US 2026/0265481 A1
(43) Pub. Date: Sep. 10, 2026

(54) Composition of Polymers Derived Through the Maleation of Depolymerized Polypropylene

(71) Applicant: GreenMantra Recycling Technologies Ltd., Brantford (CA)

(72) Inventors: Domenic Di Mondo, Brampton (CA); Irina Fenton, Burlington (CA)

(21) Appl. No.: 19/666,638

(22) Filed: May 4, 2026

Related U.S. Application Data
(63) Continuation of application No. 17/838,191, filed on Jun. 11, 2022, now Pat. No. 12,643,988.
Application No. 17/838,191 is a continuation of application No. PCT/CA2020/000141, filed on Dec. 11, 2020.
(60) Provisional application No. 62/946,647, filed on Dec. 11, 2019.

(51) Int. Cl. C08J 11/10; C08F 110/06

(52) U.S. Cl. CPC C08J 11/10; C08F 110/06; C08F 2810/00; C08J 2323/12

(57) ABSTRACT

Polymers are created via the depolymerization of a polypropylene feedstock. The polymers can be modified/grafted with maleic anhydride. In some embodiments the polypropylene feedstock contains recycled or discarded polypropylene. In some embodiments, the polymers contain olefins within the polymer backbone, and/or a suspension of iron, titanium, and/or zinc.

### CROSS-REFERENCE TO RELATED APPLICATION

This application is a continuation of and claims priority benefits from U.S. patent application Ser. No. 17/838,191 filed on Jun. 11, 2022, entitled “Composition of Polymers Derived Through the Maleation of Depolymerized Polypropylene”. The '191 application is a continuation of and claims priority benefits from International Application No. PCT/CA2020/000141 filed on Dec. 11, 2020, entitled “Composition of Polymers Derived Through the Maleation of Depolymerized Polypropylene”. The '141 application, and the present application, claim priority to U.S. provisional patent application Ser. No. 62/946,647 filed on Dec. 11, 2019, also entitled “Composition of Polymers Derived Through the Maleation of Depolymerized Polypropylene”.

The present application also claims priority to the '647 and '141 applications. The '191, '647 and '141 applications are hereby incorporated by reference herein in their entireties.

### FIELD OF THE INVENTION

The invention relates to polymers derived through the maleation of depolymerized polypropylene. In some embodiments, the polymers are made, at least in part, from recycled plastic materials. In some embodiments, the polymers are maleated polypropylene waxes.

It is advantageous to use readily available polypropylene waste as the feedstock for conversion into higher value specialty chemicals such as, but not limited to, polymers, macromonomers, and polypropylene waxes. Employing this solid waste to produce useful specialty chemicals addresses growing disposal problems. These products can be used in a variety of industries including, but not limited to, packaging; construction including road pavements, roofing materials, insulation materials, filled or reinforced composite materials, caulks, and sealants; plastic processing; agricultural films; paints; adhesives; automotive; and bookbinding.

### SUMMARY OF THE INVENTION

Polymers created via depolymerization of polypropylene feedstocks that are then maleated are disclosed along with methods and processes of forming said polymers.

In some embodiments, the composition includes at least about 1% by weight of a maleated polymer with a molecular weight between 500-45,000 atomic mass units (amu) wherein the polymer was derived from depolymerization of polypropylene plastic feedstock.

In some embodiments, the depolymerization of the polypropylene plastic feedstock is at least partially catalytic. In some embodiments, the depolymerization of the polypropylene plastic feedstock is at least partially thermal.

In some embodiments, the polypropylene feedstock comprises post-consumer derived recycled polypropylene. In some embodiments, the polypropylene feedstock comprises post-industrial derived recycled polypropylene. In some embodiments, the polypropylene feedstock comprises greater than 5% of post-consumer derived recycled polypropylene. In some embodiments, the polypropylene feedstock comprises greater than 25% of post-consumer derived recycled polypropylene.

In some embodiments, the depolymerized polymer includes at least one grafted succinate group.

In some embodiments, the polypropylene feedstock comprises between 5% to 30% of material that is other than polypropylene, based on the total weight of said polypropylene feedstock.

In some embodiments, the maleated polymer comprises greater than 0.25% olefin content on the backbone of the chain.

In some embodiments, the maleated polymer composition comprises greater than 25 ppm of zinc; greater than 50 ppm titanium; and/or greater than 50 ppm iron.

In some embodiments, the maleated polymer has an average molecular weight between 500 amu and 45,000 amu and/or a melt temperature between 130° C. and 170° C.

In some embodiments, the polymer comprises a grafted acid, such as maleic anhydride. In some embodiments, the acid number after grafting or maleation is greater than 1 mg KOH/g.

### BRIEF DESCRIPTION OF THE DRAWINGS

FIG. 1 is a flowchart illustrating a process for treating polypropylene material to create maleated or functional polymers.

FIG. 2 is a proton nuclear magnetic resonance (H NMR) spectrum for an unmaleated depolymerized polypropylene wax.

FIG. 3 is a H NMR spectrum for a maleated depolymerized polypropylene wax.

FIG. 4 is a H NMR spectrum for a polypropylene wax derived by polymerization of monomers.

FIG. 5 is a differential scanning calorimetry thermogram for an unmaleated depolymerized polypropylene wax.

FIG. 6 is a differential scanning calorimetry thermogram for a maleated depolymerized polypropylene wax.

FIG. 7 is a differential scanning calorimetry thermogram for a maleated depolymerized polypropylene wax blended with an unmaleated depolymerized polypropylene wax.

FIG. 8 is a differential scanning calorimetry thermogram for another embodiment of a maleated depolymerized polypropylene wax blended with an unmaleated depolymerized polypropylene wax.

FIG. 9 is a Fourier Transform Infrared-Attenuated Total Reflectance spectra overlay of an unmaleated depolymerized polypropylene wax and a maleated depolymerized polypropylene wax.

### DETAILED DESCRIPTION OF ILLUSTRATIVE EMBODIMENT(S)

Processes and systems for converting polypropylene material into depolymerized polymers are discussed in U.S. application Ser. No. 15/662,818 which is hereby incorporated by reference. An abbreviated description of treating polypropylene material, such as waste polypropylene material, within a reactor of a system is provided below.

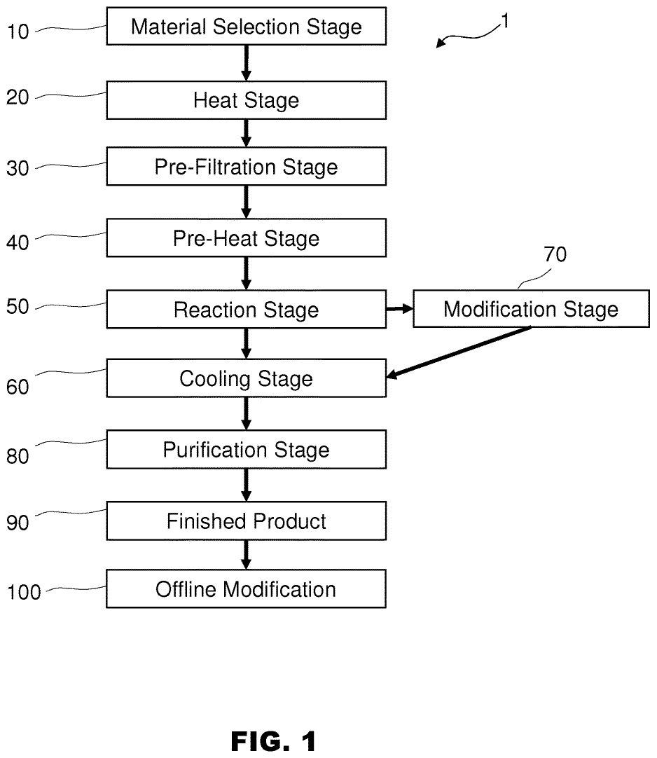

FIG. 1 illustrates Process 1 for treating polypropylene material. Process 1 can be run in batches or as a continuous or semicontinuous process. The parameters of Process 1, including but not limited to temperature, reaction or residence time, catalyst loading percent, flow rate of polypropylene, monomers/copolymers grafted during the reaction and/or modification stages, and total number of pre-heat, reaction, and/or cooling segments, can be modified to create end products of varying molecular weights, such as macromonomers, or oligomer polymer products.

For example, raising the temperature and/or decreasing the flow rate through the reaction sections or changing the number of reaction sections will result in the product of a lower molecular weight.

In some embodiments, the end products have varying molecular weights between 500 and 45,000 amu. In some preferred embodiments, the polymers have varying molecular weights between 1,000 and 30,000 amu. In other preferred embodiments, the polymers have varying molecular weights between 1,100 and 10,000 amu.

In Material Selection Stage 10, a feedstock is sorted/selected and/or prepared for treatment. In some embodiments, the feedstock is a polymeric material. In some embodiments, the polymeric material is polypropylene (PP). In other embodiments, the polymeric material includes polypropylene. In some embodiments, lower levels of polystyrene, high density polyethylene (HDPE), low density polyethylene (LDPE), linear low-density polyethylene (LLDPE), and/or other variations of polyethylene including cross-linked polyethylene, polyethylene terephthalate (PET), ethylene-vinyl acetate, polyvinyl chloride (PVC), ethylene vinyl alcohol (EVOH), and undesirable additives and/or contaminants, such as fillers, dyes, metals, various organic and inorganic additives, moisture, food waste, dirt, and/or other contaminating particles can be present in the feedstock. In some embodiments, the polymeric material comprises any one of, or combinations of, post-industrial and/or post-consumer waste polypropylene, recycled polypropylene, and/or virgin polypropylene. In some embodiments, the polypropylene material feed includes primarily virgin granules of polypropylene. The virgin granules can include various molecular weights and melt flows. In some embodiments, the recycled polypropylene is a pellet made from recycled polypropylene.

In some embodiments, the polymeric material is divided evenly by weight between polyethylene and polypropylene.

In some embodiments, the feed can contain up to 30% polyolefins other than polypropylene, PET, EVA, EVOH, and lower levels of undesirable additives or polymers, such as nylon, rubber, PVC, ash, filler, pigments, stabilizers, grit or other unknown particles. In some embodiments, the feed can contain between 5% to 30% polyolefins other than polypropylene, PET, EVA, EVOH, and lower levels of undesirable additives or polymers, such as nylon, rubber, PVC, ash, filler, pigments, stabilizers, grit or other unknown particles. In some embodiments, the feed can contain between 10% to 30% polyolefins other than polypropylene, PET, EVA, EVOH, and lower levels of undesirable additives or polymers, such as nylon, rubber, PVC, ash, filler, pigments, stabilizers, grit or other unknown particles. In some embodiments, the feed can contain between 20% to 30% polyolefins other than polypropylene, PET, EVA, EVOH, and lower levels of undesirable additives or polymers, such as nylon, rubber, PVC, ash, filler, pigments, stabilizers, grit or other unknown particles.

Suitable waste polypropylene material feeds include mixed polypropylene waste such as film, fiber caps, lids, bags, jugs, bottles, pails, and/or other items containing primarily polypropylene. The mixed polypropylene waste can include various melt flows and molecular weights. In some embodiments, the waste polypropylene material feed includes up to 30% of material that is other than polypropylene material, based on the total weight of the waste polypropylene material feed. In some embodiments, the waste polypropylene material feed includes between 5% to 30% material that is other than polypropylene material, based on the total weight of the waste polypropylene material feed. In some embodiments, the waste polypropylene material feed includes between 10% to 30% material that is other than polypropylene material, based on the total weight of the waste polypropylene material feed. In some embodiments, the waste polypropylene material feed includes between 20% to 30% material that is other than polypropylene material, based on the total weight of the waste polypropylene material feed.

In some embodiments, the recycled polypropylene is a pellet made from polypropylene waste such as film, fiber, caps, lids, bags, jugs, bottles, pails, and/or other items containing primarily polypropylene. In some embodiments, the mixed polypropylene waste can include various melt flows and molecular weights.

In some embodiments, the polypropylene feed has an average molecular weight between 100,000 amu and 5,000,000 amu. In some embodiments, the polypropylene feed has an average molecular weight between 500,000 amu and 2,500,000 amu. In some embodiments, the polypropylene feed has an average molecular weight between 750,000 amu and 1,000,000 amu.

In some embodiments, the material selected in Material Selection Stage 10 can be heated in Heat Stage 20 in an extruder and undergoes Pre-Filtration Stage 30. In some embodiments, the extruder is used to increase the temperature and/or pressure of the incoming material and is used to control the flow rates of the material. In some embodiments, the extruder is complimented by or replaced entirely by a pump/heater exchanger combination. In some embodiments, the material enters a molten state.

Pre-Filtration Stage 30 can employ both screen changers and filter beds, along with other filtering techniques/devices to remove contaminants from and purify the heated material. The resulting filtered material is then moved into an optional Pre-Heat Stage 40 which brings the filtered material to a higher temperature before it enters Reaction Stage 50. Pre-Heat Stage 40 can employ, among other devices and techniques, static and/or dynamic mixers and heat exchangers such as internal fins and heat pipes.

Material in Reaction Stage 50 undergoes depolymerization. This depolymerization can be a purely thermal reaction and/or it can employ catalysts. In some embodiments, the depolymerization of a polymeric material is a catalytic process, a thermal process, utilizes free radical initiators, and/or utilizes radiation.

In some embodiments, the catalyst used is a zeolite or alumina supported system or a combination of the two. In some embodiments, the catalyst is [Fe—Cu—Mo—P]/Al₂O₃. In some embodiments, the catalyst is prepared by binding a ferrous-copper complex to an alumina or zeolite support and reacting it with an acid comprising metals and non-metals to obtain the catalyst material. Other suitable catalyst materials include zeolite, mesoporous silica, H-mordenite and alumina. The system can also be run in the absence of a catalyst and produce lower molecular weight polymers through thermal degradation/depolymerization. In some embodiments, the catalyst is contained in a permeable container.

Depending on the starting material and the desired end product, depolymerization can be used for a slight or extreme reduction of the molecular weight of the starting material.

Reaction Stage 50 can employ a variety of techniques/devices including, among other things, fixed beds, horizontal and/or vertical reactors, and/or static mixers. In some embodiments, Reaction Stage 50 employs multiple reactors and/or reactors divided into multiple sections.

After Reaction Stage 50 the depolymerized material enters optional Modification Stage 70. In some embodiments, Modification Stage is handled in-line. In some embodiments, Modification Stage 70 involves grafting various monomers and/or copolymers such as, but not limited to, acids, alcohols, acetates, maleic anhydride, succinate. and alkenes such as hexene onto the depolymerized product.

In some embodiments, the polymeric product can be a chemically functionalized polypropylene wax such as, but not limited to, a maleated polypropylene wax or succinated polypropylene wax.

Cooling Stage 60 can employ heat exchangers, along with other techniques/devices, such as water jacketed, air cooled, and/or cooled by a refrigerant, to bring the material down to a workable temperature before it enters optional Purification Stage 80.

In some embodiments, cleaning/purification of the material via such methods such as nitrogen stripping occurs before Cooling Stage 60. In some embodiments, purging by nitrogen is used to mitigate oxidation of the molten product material and the creation of explosive conditions.

Optional Purification Stage 80 involves the refinement and/or decontamination of the polymers. Techniques/devices that can be used in Purification Stage 80 include, but are not limited to, flash separation, absorbent beds, clay polishing, distillation, vacuum distillation, nitrogen purging, thin film evaporation, vacuum devolatization, and filtration to remove solvents, oils, color bodies, ash, inorganics, ungrafted monomers and/or coke. In some embodiments, a thin or wiped film evaporator is used to remove gas, oil and/or other low molecular weight molecules from the polymer product. In certain embodiments, the desired product can be isolated via separation or extraction and the solvent can be recycled.

At Finished Product Stage 90 the initial starting material selected in Material Selection Stage 10 has been turned into a polymeric product. In at least some embodiments, the polymeric product does not need additional processing and/or refining. In other embodiments, the polymeric product created at Finished Product Stage 90 can be further modified. In some embodiments, the polymeric product is maleated.

In some embodiments, the depolymerized product is transferred into optional pelletizing or flaking product-forming equipment. In at least some embodiments, the pellets or prills of depolymerized product are between an inclusive range of about 0.1 mm to 5 mm in size. In some preferred embodiments, the pellets are between an inclusive range of about 1 mm to 2 mm in size.

At the optional Off-line Modification Stage 100 the solid depolymerized polymer can be further functionalized. Similar to Modification Stage 70, this stage can involve grafting various monomers and/or copolymers such as, but not limited to, acids, alcohols, acetates, maleic anhydride, succinate. and alkenes such as hexene onto the depolymerized product. In some embodiments the polymers can be further modified to add additional active sites such as carbonyl, ester, carboxylic acids, and/or amines. The active sites can serve functionalization purposes. In some embodiments, to improve compatibility and/or solubility with a system, various monomers and/or copolymers such as, but not limited to, acids, alcohols, acetates, acid anhydride, amines, and alkenes such as hexene, or maleic anhydride can be grafted onto the depolymerized product. In some embodiments, to improve compatibility and/or add function, the various monomers and/or copolymers are grafted on via the olefin fingerprint and/or aromatic functionality.

Grafting can take place, among other places, in the reactor, in line with the stream after cooling, and/or in a separate vessel.

In some embodiments, the polymeric product can be a chemically functionalized polypropylene wax such as, but not limited to, a maleated polypropylene wax or succinated polypropylene wax.

In some embodiments, the maleated polypropylene wax, that is, polypropylene wax grafted with maleic anhydride, can have a viscosity between an inclusive range of about 10 cps-20,000 cps measured at 190° C. (as measured by ASTM D1986), a drop point between an inclusive range of about 130° C.-170° C. (as measured by ASTM D3954), and/or an acid number between an inclusive range of about 1 mg KOH/g-50 mg KOH/g (as measured by ASTM D7389).

In some preferred embodiments, the maleated polypropylene wax has a viscosity between an inclusive range of 50 cps-5,000 cps measured at 190° C. (as measured by ASTM D1986), a drop point between an inclusive range of 140° C.-170° C. (as measured by ASTM D3954), and/or an acid number between an inclusive range of 5 mg KOH/g-35 mg KOH/g (as measured by ASTM D7389).

In other preferred embodiments, the maleated polypropylene wax has a viscosity between an inclusive range of 75 cps-3,500 cps measured at 190° C. (as measured by ASTM D1986), a drop point between an inclusive range of 150° C.-170° C. (as measured by ASTM D3954), and/or an acid number between an inclusive range of 7 mg KOH/g −30 mg KOH/g as (measured by ASTM D7389).

Functionalized polymers derived from depolymerized waste polypropylene polymers, such as polypropylene plastics, have different properties compared to the starting polymer/plastic feedstock and traditional functionalized polypropylene polymers synthesised via fossil sources.

The controlled depolymerization of polypropylene polymers, such as polypropylene plastics, can create polymers with lower molecular weights and greater polarity. The ability to tune the properties of the polymers derived from depolymerized polypropylene polymers, such as polypropylene plastics, allows polymer products to be designed specifically for particular uses.

For example, mid-molecular weight polymers produced via the depolymerization of polypropylene can contain specific structural or chemical properties, including but not limited to, olefin content and/or longer aliphatic sections near terminal positions of the chain. In some embodiments, polymers produced via the depolymerization of polypropylene can contain a specific fingerprint of inorganic elements and carbonyl functional groups.

In some embodiments, the polymers produced via depolarization of polypropylene comprise at least one olefin on the backbone of the chain, typically near a terminal position. In certain embodiments, the olefin content is greater than and inclusive of 0.25% of the total weight of the polymer.

In at least some embodiments, the polymers produced via depolarization of polypropylene are soluble in organic mediums and/or aqueous formulations.

Polymers derived from depolymerized polypropylene can be used where traditional higher molecular weight polypropylene polymers, such as polypropylene plastics, could not be used without modification. Such applications include, but are not limited to, additives for plastic processing (extrusion, injection molding, blow molding, blown and cast films, etc.), additives for asphalt roofing and pavements, and as additives to various adhesives.

In addition, the use of polymers derived from waste polypropylene polymers, such as polypropylene plastics, can help reduce greenhouse gases, landfill waste, and the need to produce new products derived from fossil or virgin polypropylene.

### Illustrative Examples

In an illustrative embodiment, several formulations of maleated and unmaleated depolymerized polypropylene were produced. See Table 1.

TABLE 1
Formulations

| | | Formulation | | | |
|---|---|---|---|---|---|
| | | A | B | C | D |
| Component | Unmaleated depolymerized | 100% | 0 | 34% | 67% |
| | polypropylene wax | | | | |
| | Maleated depolymerized | 0 | 100 | 66% | 33% |
| | polypropylene wax | | | | |

The unmaleated depolymerized polypropylene wax (Formulation A) comprises a wax created via the depolymerization of polypropylene waste as described above and in U.S. application Ser. No. 15/662,818. The unmaleated depolymerized polypropylene wax has a density of about 0.90 g/cm³ (ASTM D1298), a viscosity of about 75 cps at 190° C., and a drop point of about 155° C. (ASTM D3954).

Maleated (Formulation B) was prepared by a reactive modification of 88.8 percent by weight of Unmaleated (Formulation A) with 10 percent by weight of maleic anhydride and 1.2 percent by weight of peroxide (Luperox DBHP). Modification was conducted in a ZSK 92MC extruder (twin screw) between 150-175° C., followed by a double cooler belt (pastillator).

Various formulations of maleated depolymerized polypropylene wax can be created by adjusting the ratio of the unmaleated depolymerized polypropylene wax, maleic anhydride, and peroxide. In some embodiments, the amount of unmaleated depolymerized polypropylene wax is between and inclusive of 80 to 95 percent by weight. In some embodiments, the amount of unmaleated depolymerized polypropylene wax is between and inclusive of 85 to 90 percent by weight. In some embodiments, the amount of maleic anhydride is between and inclusive of 4.9 to 19.9 percent by weight. In some embodiments, the amount of maleic anhydride is between and inclusive of 10 to 15 percent by weight. In some embodiments, the amount of peroxide is between and inclusive of 0.1 to 2.5 percent by weight. In some embodiments, the amount of peroxide is between and inclusive of 0.5 to 1 percent by weight.

Formulations C and D were produced by blending Formulation A and Formulation B in the ratios indicated. However, Formulation C and Formulation D could also be produced by a reactive modification of Formulation A with maleic anhydride and peroxide in which the ratios of Formulation A, maleic anhydride and peroxide are adjusted accordingly.

TABLE 2
Properties of Resulting Polymers

| | Formulation | | | |
|---|---|---|---|---|
| | A | B | C | D |
| MW | 5168 | 9133 | 6551 | 6142 |
| (Weight-average molecular | | | | |
| weight) | | | | |
| MN | 2008 | 649 | 1473 | 1311 |
| (Number-average molecular | | | | |
| weight as determined by gel | | | | |
| permeation chromatography) | | | | |
| MW/MN | 2.57 | 14.1 | 4.4 | 4.7 |
| Acid Number | 0 | 35 | 20 | 10 |
| AN (Bound) | 0 | 35-37 | 18-22 | 8-12 |
| ASTM D7389, mg KOH/g | | | | |
| Drop Point | 155 | 156 | 156 | 155 |
| ASTM D3954 | | | | |
| ° C. | | | | |
| Viscosity (190 C.) | 75 | 330 | 180 | 126 |
| ASTM D1986, cPs | | | | |
| Iron (ppm by XRF) | 756 | 177 | 124 | 140 |
| Titanium (ppm by XRF) | 1721 | 4321 | 2386 | 2892 |
| Zinc (ppm by XRF) | 37 | 54 | 43 | 53 |

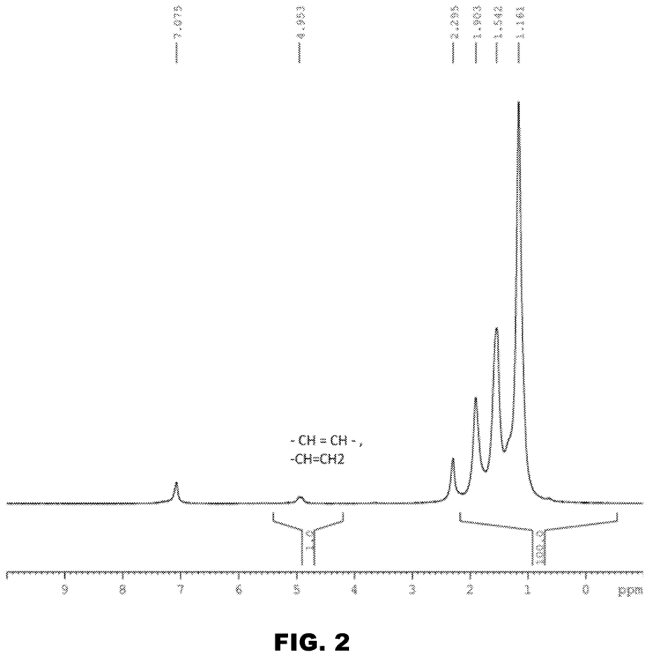

FIG. 2 shows a H NMR spectrum of Formulation A. The peaks in the 4.8-5.7 area correspond to unsaturated bonds.

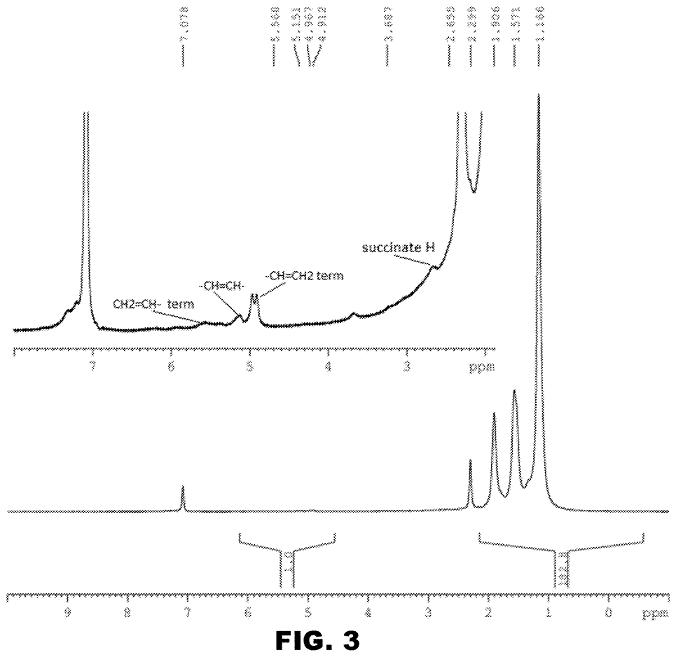

FIG. 3 is a H NMR spectrum for Formulation B. Peaks around 4.8-5.7 demonstrate unsaturated bonds. The peak at 2.6 shows the presence of grafted succinate groups. These additional functional groups allow the resulting material to be more easily incorporated into a broader range of systems due to its high degree of polarity. In addition, the higher degree of polarity in the system due to the addition of malic functional groups can allow the malleated product to compatibilize dissimilar systems, including but not limited to, mixed plastic streams and/or polymer modified asphalt formulations containing styrene-butadiene-styrene (SBS).

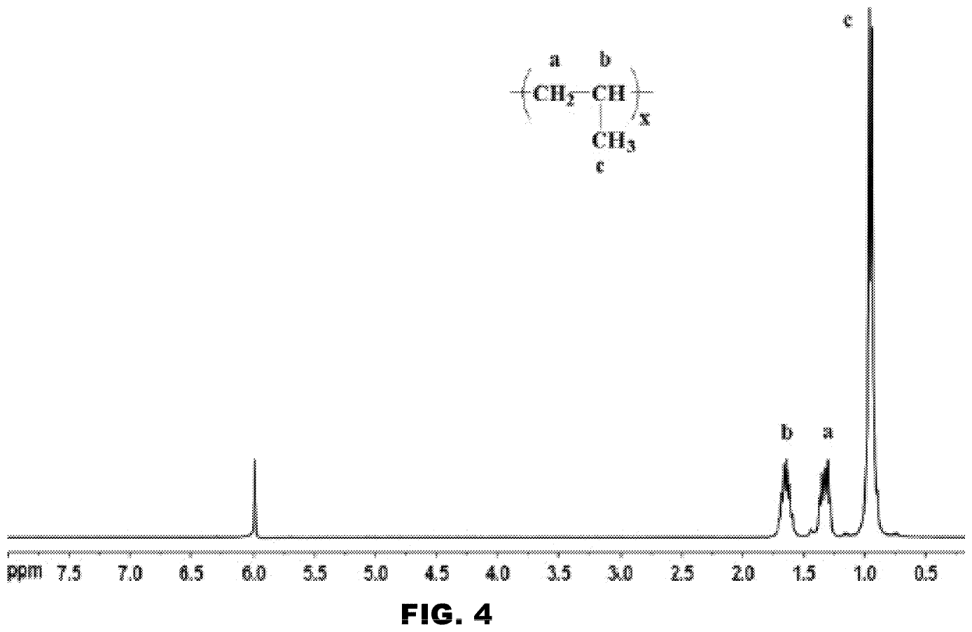

FIG. 4 is a H NMR spectrum for a polypropylene wax derived by polymerization of monomers. The lack of peaks in the 4.8-5.7 area illustrates a lack of unsaturated bonds.

FIG. 2 and FIG. 3 show that the polymers created via depolymerization contain active sites (such as olefin moieties). These active sites are a signature of materials produced via a depolymerization process. Backbone or terminal olefins are identifiable features that are not present in polymers derived through polymerization methods (see FIG. 4).

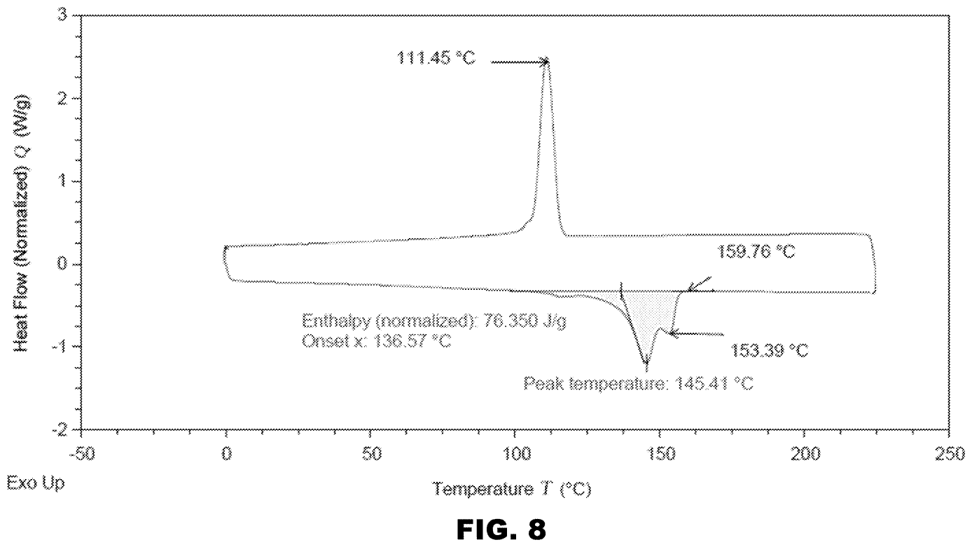

Backbone or terminal olefins, which involve double bonded carbon atoms, are more polar in nature compared to polymers with saturated backbones such as those created via polarization and shown in FIG. 8. This makes polymers with olefin content more compatible in various organic and aqueous solvent formations than traditional polypropylene. In addition, the added olefin content can allow the polymer to act as a site for coupling or crosslinking with other monomers or polymer systems.

As demonstrated via x-ray fluorescence (see Table 2), in at least some embodiments, the resulting compositions include greater than 25 ppm of iron; greater than 25 ppm of zinc; and/or greater than 50 ppm of titanium. The presence of these metals confirms that the polymer was derived through either post-consumer or post-industrial waste polypropylene polymers, such as polypropylene plastics. As the metals are dispersed in the polymers, they add both polarity and reactivity. In at least some embodiments, this can make the polymers more compatible in various organic and aqueous solvent formations than traditional polypropylene. In addition, the added metal content can allow the polymer to act as a coupling agent with other multi-polymer systems. The presence of metals can contribute to nucleating properties of the material when mixed with other polymers.

In at least some embodiments, the presence of titanium contributes to UV-resistance properties. In at least some embodiments, the presence of zinc contributes to thermal stability of the materials.

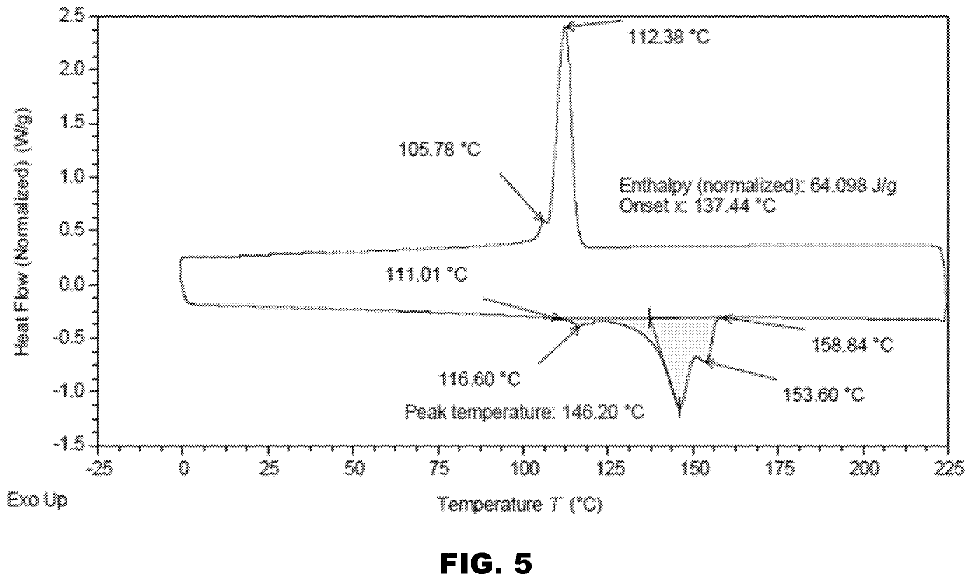

FIG. 5 is a differential scanning calorimetry thermogram for Formulation A (determined via ASTM D3418).

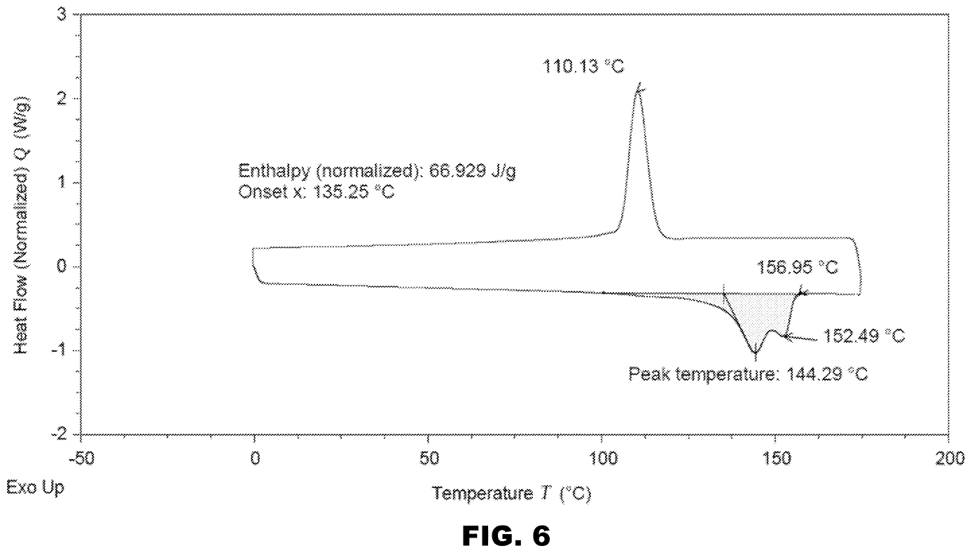

FIG. 6 is a differential scanning calorimetry thermogram for Formulation B (determined via ASTM D3418).

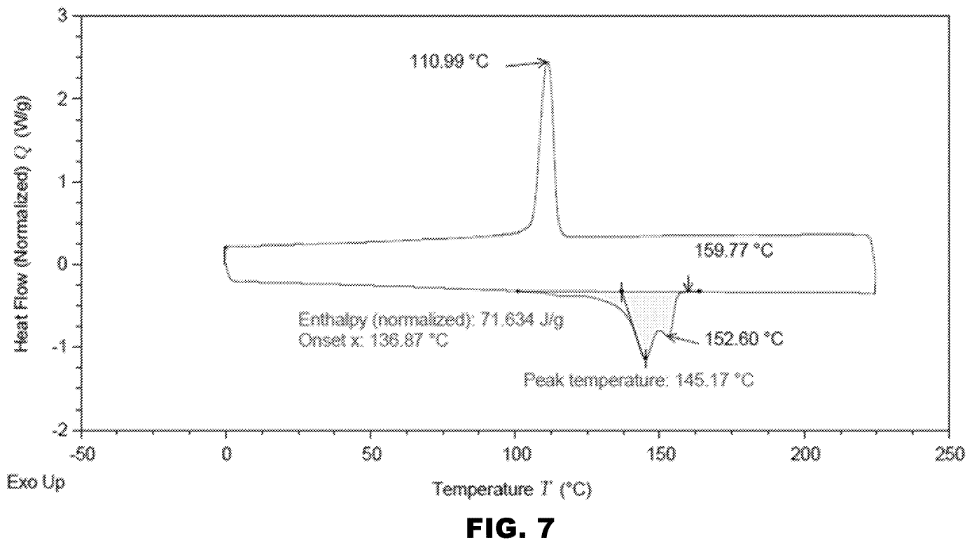

FIG. 7 is a differential scanning calorimetry thermogram for Formulation C (determined via ASTM D3418).

FIG. 8 is a differential scanning calorimetry thermogram for Formulation D (determined via ASTM D3418).

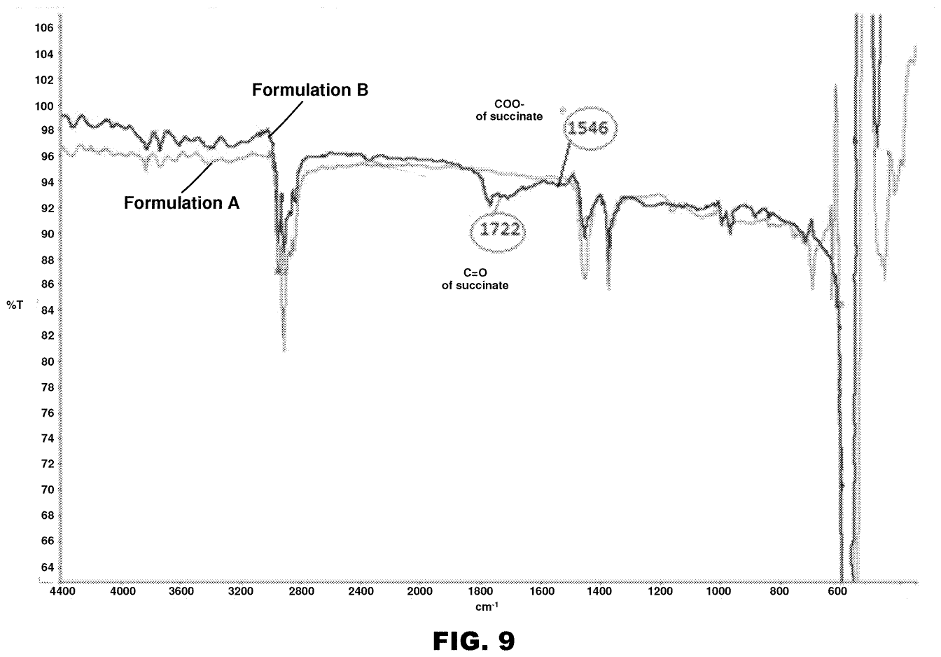

FIG. 9 is a Fourier Transform Infrared—Attenuated Total Reflectance spectra overlay of Formulation A and Formulation B. The presence of characteristic peaks at 1722 cm (−1) and 1546 cm (−1) on the spectrum for Formulation B demonstrates the succinate chemical groups bound to polypropylene which proves successful maleation process.

Terms such as “about” should be understood to have the meanings one skilled in the art would apply to them given the context. In some embodiments, “about” can mean plus or minus five percent.

While particular elements, embodiments and applications of the present invention have been shown and described, it will be understood, that the invention is not limited thereto since modifications can be made without departing from the scope of the present disclosure, particularly in light of the foregoing teachings. For example, the numerous embodiments demonstrate that different combinations of components are possible within the scope of the claimed invention, and these described embodiments are demonstrative and other combinations of the same or similar components can be employed to achieve substantially the same result in substantially the same way. Further, all of the claims are hereby incorporated by reference into the description of the preferred embodiments.

What is claimed is:

1. A composition comprising:
a depolymerized polymer wherein said depolymerized polymer has been maleated,
wherein said depolymerized polymer is derived from depolymerization of a polypropylene feedstock via a depolymerization process.

2. The composition of claim 1 wherein said composition further comprises greater than 25 ppm zinc.

3. The composition of claim 2 wherein said polypropylene feedstock comprises recycled polypropylene.

4. The composition of claim 2 wherein said depolymerized polymer comprises greater than 0.25% olefin content on the backbone of the chain.

5. The composition of claim 2 wherein said depolymerized polymer has a weight-average molecular weight between and inclusive of 500-45,000 atomic mass units.

6. The composition of claim 2 wherein said depolymerized polymer has been maleated to an acid number greater than 1 mg KOH/g.

7. The composition of claim 1 wherein said composition further comprises greater than 50 ppm titanium.

8. The composition of claim 7 wherein said polypropylene feedstock comprises recycled polypropylene.

9. The composition of claim 7 wherein said depolymerized polymer comprises greater than 0.25% olefin content on the backbone of the chain.

10. The composition of claim 7 wherein said depolymerized polymer has a weight-average molecular weight between and inclusive of 500-45,000 atomic mass units.

11. The composition of claim 7 wherein said depolymerized polymer has been maleated to an acid number greater than 1 mg KOH/g.

12. The composition of claim 1 wherein said composition further comprises greater than 25 ppm iron.

13. The composition of claim 12 wherein said polypropylene feedstock comprises recycled polypropylene.

14. The composition of claim 12 wherein said depolymerized polymer comprises greater than 0.25% olefin content on the backbone of the chain.

15. The composition of claim 12 wherein said depolymerized polymer has a weight-average molecular weight between and inclusive of 500-45,000 atomic mass units.

16. The composition of claim 12 wherein said depolymerized polymer has been maleated to an acid number greater than 1 mg KOH/g.

17. The composition of claim 1 wherein said depolymerized polymer comprises at least one grafted succinate group.

18. The composition of claim 17 wherein said polypropylene feedstock comprises recycled polypropylene.

19. The composition of claim 17 wherein said depolymerized polymer has a weight-average molecular weight between and inclusive of 500-45,000 atomic mass units.

20. The composition of claim 17 wherein said depolymerized polymer has been maleated to an acid number greater than 1 mg KOH/g.
